(19) United States
(12) Patent Application Publication
(10) Pub. No.: US 2012/0257250 A1
(43) Pub. Date: Oct. 11, 2012

(54) PRINT CONTROL METHOD AND DEVICE

(75) Inventors: Qiangzi Cong, Weihai (CN); Jiabo Xu, Weihai (CN); Chunguang Ma, Weihai (CN); Chuntao Wang, Weihai (CN); Lei Che, Weihai (CN)

(73) Assignee: Shandong New Beiyang Information Technology Co., Ltd., Shandong (CN)

(21) Appl. No.: 13/516,448

(22) PCT Filed: Oct. 25, 2010
(86) PCT No.: PCT/CN10/78070

§ 371 Date: Jun. 15, 2012

Related U.S. Application Data
(66) Substitute for application No. PCT/CN2010/078070, filed on Oct. 25, 2010.

(30) Foreign Application Priority Data
Dec. 18, 2009 (CN) 200910259610.2

(51) Int. Cl. G06K 15/02

(52) U.S. Cl. 358/1.15

(57) ABSTRACT

The invention provides a print control method, comprising the steps of: detecting a state of a printing paper of a printing device; acquiring the length of a ticket to be printed when the printing device is in a paper near end state; judging whether the printing paper in the printing device is enough to print the ticket to be printed completely according to the length of the ticket to be printed; and printing the ticket to be printed under the condition of determining that the ticket to be printed can be completely printed. The invention also provides a print control device.

### TECHNICAL FIELD OF THE INVENTION

The invention relates to the printing field, and particularly to a print control method and device.

### BACKGROUND OF THE INVENTION

The printing devices using the roll paper, such as receipt printers in the retail industry, various journal printers, lottery printer or the like, usually use paper rolls with very long length so as to facilitate the use and reduce the workload of manual replacement of paper. A prompt message is sent out when the residual amount of paper is very small (hereinafter referred to as paper near to end) during the printing, so as to prompt the user to replace the paper or use it carefully and prevent that the printed receipt is incomplete, wherein for example supermarket receipts, lottery tickets or the like are not allowed to half-baked.

The related art discloses a device using paper roll (a roll of paper) and detecting whether the paper is near end, wherein the device is used for detecting the residual amount of the paper roll. The detailed description is as shown in FIG. 1 and FIG. 2.

FIG. 1 is a schematic diagram illustrating that a paper house in a printing device accommodates a relatively larger paper roll according to the related art; FIG. 2 is a schematic diagram illustrating that a paper house in a printing device accommodates a relatively smaller paper roll according to the related art.

As shown in FIG. 1, a paper roll (a roll of paper) 110 is placed in a paper house 100, and the side wall of the paper house is provided with a paper near end detection mechanism 142. When residual amount of paper of the paper roll 110 in the paper house 100 is very large, the paper near end detection mechanism 142 can receive optical signals sent by the mechanism and reflected by the paper roll. Along with the continuous printing of the paper, the amount of the paper of the paper roll 110 decreases continuously. When the residual amount of the paper of the paper roll is decreased to the degree as shown in FIG. 2, since the paper roll cannot reflect the optical signals sent by the paper near end detection mechanism 142, so as to cause the paper near end detection mechanism's detection result is changed, the information that the roll paper in the paper roll 110 is to be used up is reported to the printing device, i.e., the paper is near end. The disadvantage of the art lies in that when the amount of the paper in the paper roll becomes less and less, the weight of the paper roll also gradually decreases. As the paper roll easily moves in the paper house during paper feeding, it affects the detection performed by the paper near end detection mechanism on the paper roll. Therefore, it is impossible to accurately detect the residual amount of the paper in the paper roll when the paper roll is relative smaller. In order to prevent the detection error of the paper near end detection device, the conventional printer usually gives an alarm that the paper is near end when the residual amount of the paper is 1.5 m to 2.5 m, resulting in the waste of paper.

A method is disclosed in the related art. The method detecting whether the paper is near end, which is disclosed in the method, can detect the tail end of the roll paper relatively accurately to make the residual amount of the paper in the paper roll less. During the printing, a method is used, wherein in the method the amount of paper for printing at this time is deducted from the original length of the paper roll every time of printing, so as to make the residual amount of the paper in the paper roll reach the expected value. As the printing device inevitably has error of feeding paper in the aspect of mechanical structure during printing, in order to ensure the completeness of the printed ticket, in actual use, when the residual amount of the paper reaches the expected value, i.e., when the tail end of the paper roll is detected, a small amount of paper is still remained on the paper roll.

A method is disclosed in the related art. By the method, the tail end of the roll paper can be detected reliably and accurately to ensure the minimum amount of residual paper. Special marks are added at the tail end of the roll paper, a sensor is added into the printing device to detect these marks, and the tail end of the paper roll is identified through detecting these special marks. Because the detection method is only suitable for paper with special marks, and cannot be implemented on ordinary roll paper, the method does not have universality. Because a small amount of paper including the paper with special marks is still remained on the paper roll wherein the tail end has been detected, this method does not use the paper in the paper roll to the limit, i.e., the residual amount of the paper is not limited within one printed ticket length.

A solution has not yet been proposed for the problem that the ticket cannot be printed completely due to insufficient residual paper during printing in the related art.

### SUMMARY OF THE INVENTION

The invention is provided for the problem that the ticket cannot be printed completely due to insufficient residual paper during printing in the related art. To this end, one main purpose of the invention is to provide a print control method and device to solve the above problem.

In order to achieve the above object, according to one aspect of the invention, there is provided a print control method.

The print control method according to the invention comprises: detecting a state of a printing paper of a printing device; acquiring the length of a ticket to be printed when the printing device is in a paper near end state; judging whether the printing paper in the printing device is enough to print the ticket to be printed completely according to the length of the ticket to be printed; and printing the ticket to be printed under the condition of determining that the ticket to be printed can be completely printed.

Preferably, the step of detecting a state of a printing paper of a printing device comprises: judging whether the printing device is in the paper near end state through querying a state of a paper near end sensor.

Preferably, the step of judging whether the printing paper in the printing device is enough to print the ticket to be printed completely according to the length of the ticket to be printed comprises: feeding paper by the printing device according to a set length; comparing an actual feeding length of the printing device with the set length; judging whether the printing paper in the printing device is enough to print the ticket to be printed completely according to the comparison result.

Preferably, when the printing paper in the printing device is enough to print the ticket to be printed completely, the method further comprises: moving back paper according to the set length.

Preferably, the set length is the length of the ticket to be printed or the difference between the length of the ticket to be printed and a LS, wherein the LS is a distance between a paper absent detection mechanism and a printing position.

Preferably, the ticket to be printed is a ticket with a fixed length or a ticket with a random length, when the ticket to be printed is the ticket with a fixed length, the step of acquiring the length of the ticket to be printed comprises: acquiring the length of the ticket to be printed according to the length of the ticket with a fixed length prestored.

Preferably, the ticket to be printed is a ticket with a fixed length or a ticket with a random length, when the ticket to be printed is the ticket with a random length, the step of acquiring the length of the ticket to be printed comprises: calculating the length of the ticket to be printed according to received print data of the ticket to be printed.

Preferably, when the printing device is in a paper absent state, the method further comprises: providing an alarm for a user.

In order to achieve one of above purpose, according to another aspect of the invention, there is provided a print control device.

The print control device according to the invention comprises: a detecting module, configured to detect a state of a printing paper of a printing device; an acquiring module, configured to acquire the length of a ticket to be printed when the printing device is in a paper near end state; a judging module, configured to judge whether the printing paper in the printing device is enough to print the ticket to be printed completely according to the length of the ticket to be printed; and a printing module, configured to print the ticket to be printed under the condition of determining that the ticket to be printed can be completely printed.

Preferably, the device further comprises: an alarm module, configured to provide an alarm for a user when the printing device is in a paper absent state.

By the invention, the problem that the ticket cannot be printed completely due to insufficient residual paper during printing is solved by detecting a state of a printing paper of a printing device, acquiring the length of the ticket to be printed when the printing device is in the paper near end state, judging whether the printing paper in the printing device is enough to print the ticket to be printed completely according to the length of the ticket to be printed, and printing the ticket to be printed under the condition of determining that the ticket to be printed can be completely printed, so as to reach the effect that the residual amount of the paper can be detected in time, thereby avoiding the problem that the ticket cannot be completely printed.

### BRIEF DESCRIPTION OF THE DRAWINGS

The accompanying drawings described herein are included to provide a further understanding of the invention, and constitute a part of the application. The example embodiments and description thereof of the invention are intended to explain the invention, and do not constitute improper restriction to the invention. In the drawings:

FIG. 1 is a schematic diagram illustrating that a paper house in a printing device accommodates a relatively larger paper roll according to the related art;

FIG. 2 is a schematic diagram illustrating that a paper house in a printing device accommodates a relatively smaller paper roll according to the related art;

FIG. 3 is a schematic diagram of a print control device according to embodiment one of the invention;

FIG. 4 is a flowchart in which a sample ticket is printed during continuous printing according to the embodiment of the invention;

FIG. 5 is a schematic diagram of a paper feeding path of a print control device according to embodiment two of the invention;

FIG. 6 is a flowchart of a preferred print control method according to embodiment three of the invention;

FIG. 7 is a schematic diagram of a control method of calculating a printing length according to the embodiment of the invention;

FIG. 8 is a flowchart of determining whether the residual amount of paper in a paper roll is enough to print a ticket completely according to the embodiment of the invention; and

FIG. 9 is a schematic diagram of a print control device according to the embodiment of the invention.

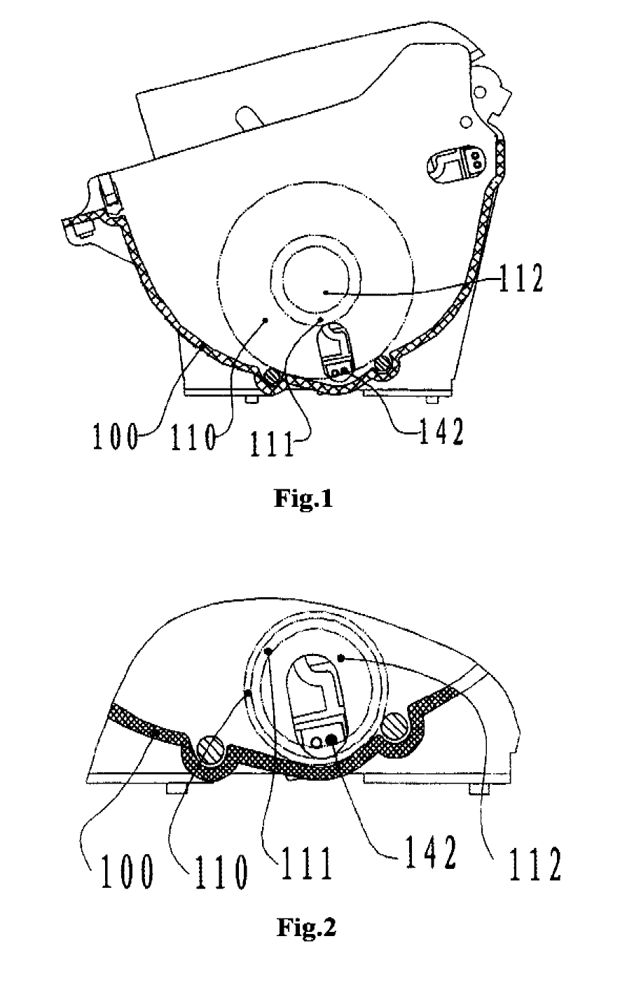

### DETAILED DESCRIPTION OF THE INVENTION

It should be noted that, without conflict, the embodiments in the application and features in the embodiments may be combined with each other. The invention will be described in detail below with reference to the drawings and in conjunction with the embodiments.

According to the embodiments of the invention, there is provided a print control method and device.

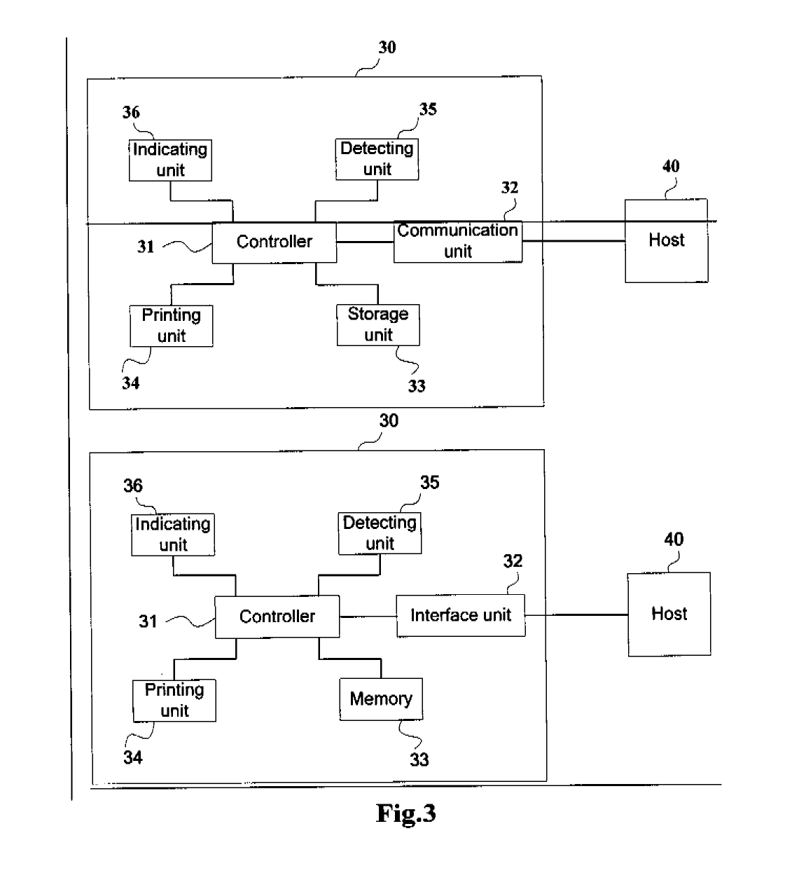

FIG. 3 is a schematic diagram of a print control device according to embodiment one of the invention.

The print control device is a printing device which not only can reduce the residual amount of paper but also can ensure the completeness of the printed ticket. In the process of printing ticket, when the residual amount of paper in the printer is small, i.e., when the paper is near end, the device compares the residual amount of paper with the length of the ticket before printing one ticket, determines whether the residual amount of paper is enough to print the ticket content completely, and prints it when the residual amount of paper is enough to print the ticket completely, otherwise provide an alarm or a prompt.

As shown in FIG. 3, the print control device comprises a controller 31, an interface unit 32, a memory 33, a printing unit 34, a detecting unit 35 and an indicating unit 36.

In the above, the controller 31 controls data interaction between itself and a host, such as receiving print data of the ticket, sending a paper state of the printing device: a paper present state, a paper near end state, a paper absent state or the like, controlling an operation of feeding paper and an operation of moving back paper during the printing, controlling a printing operation of the printing unit, calculating the length of the ticket to be printed, and comparing the residual amount of paper in the paper roll with the printing length. The communication unit 32 provides access for the data communication between the printing device and the host, such as receiving print data, sending various states of the printing device wherein the various states include paper state or the like. The memory 33 stores the data sent from the host, stores the data to be printed by the printing unit, stores the detection data of the detecting unit 36, and stores the printing length of each ticket, etc. The printing unit 34 prints the data to be printed according to the requirements of the controller, wherein the printing unit can be a thermal transfer printing unit, can also be a ribbon printing unit, or an inkjet printing unit, etc. The detecting unit 35 detects whether the printer is lack of paper, and detects the residual amount of paper of the paper roll, etc. The indicating unit 36 indicates the state of the printing device by means of sound, light or the like according to the request of the controller 31, wherein the state comprises: a normal state, a paper near end state, or a paper absent state. The indication by sound, for example, comprises using a buzzer and a speaker to create sound. The indication by light, for example, comprises using a light emitting diode, a liquid crystal display or the like to perform visual indication.

The implementation function of each composition unit and the simple working relationship between them can be directly obtained from the composition diagram of the printing device of FIG. 3. Particularly, the printing device may also comprise a paper separation device, such as a cutter, a paper tearing knife or the like.

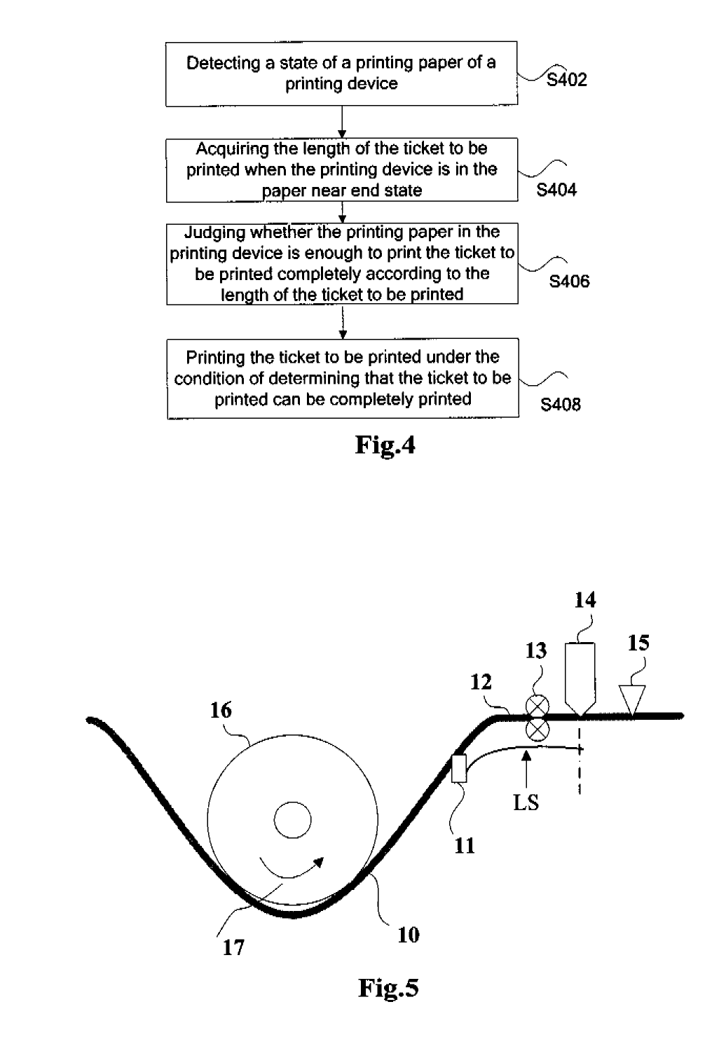

FIG. 4 is a flowchart in which a sample ticket is printed during continuous printing according to the embodiment of the invention.

As shown in FIG. 4, the method comprises step S402 to step S410 as follows:

Step S402: detecting a state of a printing paper of a printing device;

Step S404: acquiring the length of a ticket to be printed when the printing device is in the paper near end state;

Step S406: judging whether the printing paper in the printing device is enough to print the ticket to be printed completely according to the length of the ticket to be printed;

Step S408: printing the ticket to be printed under the condition of determining that the ticket to be printed can be completely printed.

In order to achieve the above purpose, according to another aspect of the invention, there is provided a print control device.

The implementation process of the embodiment of the invention will be described in detail below in conjunction with examples.

FIG. 5 is a schematic diagram of a paper feeding path of a print control device according to embodiment two of the invention.

The schematic diagram of the paper feeding path of the print control device according to the embodiment is used for illustrating the actual position relationship between main composition units of the printing device and the function of the composition unit in the whole operation process of the device.

As shown in FIG. 5, the paper feeding path of the print control device comprises a paper accommodating mechanism 10, a paper absent detection mechanism 11, a paper feeding path 12, a paper feeding mechanism 13, a printing mechanism 14, a paper cutting mechanism 15, roll paper 16 and a paper near end detection mechanism. The LS is the distance between the paper absent detection mechanism and the printing mechanism (or printing position), wherein the paper near end detection mechanism is not marked in the figure.

The paper accommodating mechanism 10, the paper absent detection mechanism 11, the paper feeding mechanism 14, the printing mechanism 13, and the paper cutting mechanism 15 are distributed orderly in the paper feeding path 12 of the printing device in the direction in which the printing media are transferred. The paper accommodating mechanism 10 accommodates the roll paper 16. The paper absent detection mechanism 11 is between the paper accommodating mechanism 10 and the printing mechanism 13 and ensures that it is possible to detect whether there is paper on the paper roll in the paper accommodating mechanism before the printing mechanism performs printing. The paper cutting mechanism 15 is located behind the printing mechanism, so as to be convenient to cut the paper of the printed ticket. The paper roll in the paper accommodating mechanism 10 is fed in the path 12 in the direction shown by arrow 17. The paper feeding mechanism 13 drives the printing paper to move forward in the path. The paper cutting mechanism 15 performs paper cutting operation on the printing paper and cuts the continuous paper into individual ticket, which is convenient for taking it away by the users. The paper absent detection mechanism 12 detects whether there is paper in the paper feeding path, i.e., whether the paper of the roll paper 16 in the paper accommodating mechanism 10 is used up. The detection mechanism can be a photoelectric detection device, or a mechanical detection device, or also can be a sonar detection device or the like. The photoelectric detection device commonly used comprises a reflective sensor, a transmission sensor, or the like. The paper near end detection mechanism detects whether the paper in the roll paper 16 is to be used up. The printing paper is driven by the paper feeding mechanism to be transmitted in the path, the printing paper is printed by the printing mechanism, the paper is cut by the paper cutting mechanism, so as to finish both the printing and cutting of the ticket.

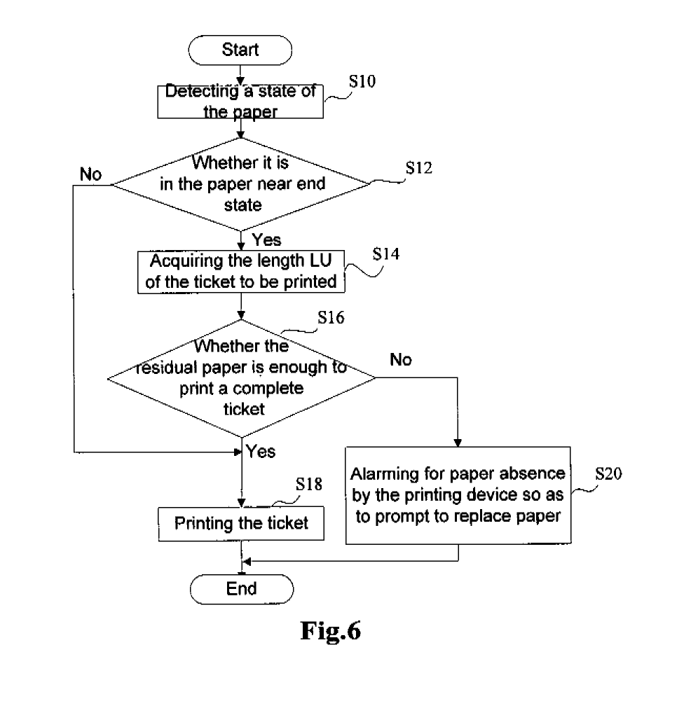

FIG. 6 is a flowchart of a preferred print control method according to embodiment three of the invention.

As shown in FIG. 6, the preferred print control method comprises the following steps:

Step 10: Detecting the state of the paper.

The printing device first judges the state of the paper before printing. The paper state comprises a normal state, a paper near end state, a paper absent state, or the like. In the above, the paper near end state is detected by the paper near end detection mechanism, and the paper absent state is detected by the paper absent detection mechanism. The state of the paper of the printing device during the use of the roll paper changes along with continuous decrease of residual amount of paper and is orderly a normal state, a paper near end state and a paper absent state, i.e., when the residual amount of paper continuously decreases during printing, the paper of the roll is less than the predetermined residual amount of paper detected by the paper near end detection mechanism, the paper near end state is detected firstly, then the paper absent state is detected. A method of detecting whether the paper is near end can be implemented by a known technology and will not be described here redundantly.

Step S12: Judging whether the printing device is in the paper near end state. If yes, Step S14 is executed, otherwise Step S20 is executed.

When the printing device is in the paper near end state, it is indicated that the residual amount of paper in the paper roll is very small, it is necessary to determine whether the residual amount of paper can meet the length requirement of the ticket to be printed during the printing of the ticket. When the printing device does not enter the paper near end state, it is indicated that the residual amount of paper in the paper roll is large, and the ticket can be printed directly.

Step S14: Acquiring the length LU of the ticket to be printed.

When the printing device is in actual use, the ticket with a fixed length can be printed, or the ticket with a random length can be printed. Printing the ticket with a fixed length or printing the ticket with a random length is suitable for different application occasions, wherein printing the ticket with a random length is suitable for the occasion that the printed content changes randomly, such as printing the supermarket shopping receipt, or printing the information inquiry content. Printing the ticket with a fixed length is suitable for the occasion that the printed content is relatively fixed, such as printing the taxi receipts, printing purchase invoices.

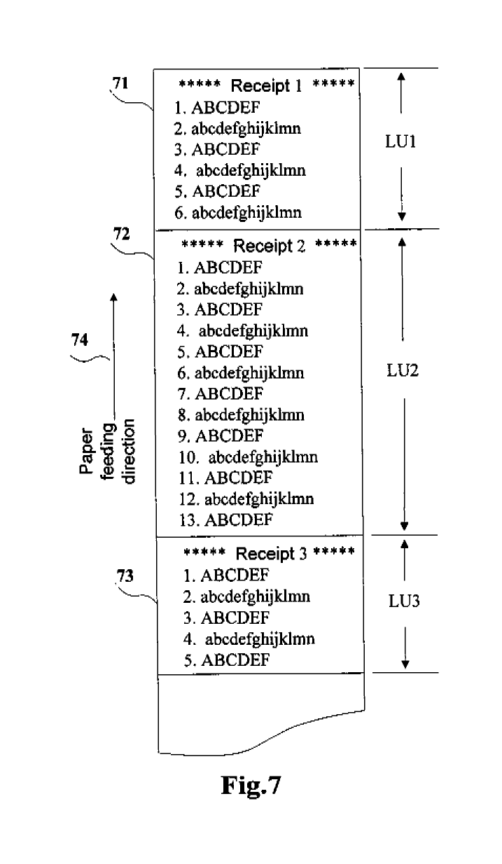

When the printing device prints the ticket with a fixed length, the length of the printed ticket is determined without calculation. When length of the printed ticket is not fixed, the printing length of the ticket needs to be calculated. The ticket with the length which is randomly changed is as shown in FIG. 7.

FIG. 7 is a schematic diagram of a control method of calculating a printing length according to the embodiment of the invention.

As shown in continuous paper printing in FIG. 7, when the ticket with a random length is printed, it is printed along the paper feeding direction shown by arrow 74. The amount of print data of receipt 71, receipt 72 and receipt 73 and the number of the lines of print data are changed widely. The lengths LU1, LU2, LU3 of the ticket are also changed widely, where LU2>LU1>LU3. It can be seen from the figure that in comparison with printing the ticket with a fixed length, printing the ticket with a random length saves paper.

When the printing device prints the ticket with a random length, since the content of the ticket to be printed change randomly every time, the length of the printed ticket is undetermined, the length of the ticket to be printed needs to be calculated before each printing. The length of the ticket is specifically referred to be the number of the dot line or the number of the pixel line of printed information in the paper feeding direction. The calculation method thereof is as follows: when the printed data received by the printing device are image data, i.e., when the received data are printed directly, all graphic data of the printed ticket received are first stored in the memory, then the number of the dot line or the number of the pixel line of printed information in the paper feeding direction shown by arrow 74 in FIG. 7 is calculated. When the printed data received by the printing device are character data, the character data are first converted into graphic data, then the length of the ticket of the graphic data is calculated.

Step S16: Judging whether the length of the residual paper is enough to print a complete ticket. If the judgment result is yes, Step S18 is executed, otherwise Step S20 is executed.

After the printing device detects that the paper is near end, the residual amount of paper of the paper roll has been relatively small, there is a chance that the paper is used up at any time. In order to prevent printed ticket from being incompletely printed since the paper is used up, it is necessary to compare the length of residual paper with the length of the ticket to be printed, thereby it is judged whether the residual paper is enough to print the ticket completely. If the length of residual paper is greater than the length of the ticket to be printed, it is indicated that the residual paper is enough to print the ticket completely, and thus, the Step S18 is executed for the printing. If the length of residual paper is smaller than the length of the ticket to be printed, it is indicated that the residual paper is not enough to print the ticket completely, and thus, the Step S20 is executed to prompt the user to replace a new paper roll.

Preferably, the step of judging whether the printing paper in the printing device is enough to print the ticket to be printed completely according to the length of the ticket to be printed comprises steps of: feeding paper by the printing device according to a set length; comparing a feeding length with the set length of the printing device; judging whether the printing paper in the printing device is enough to print the ticket to be printed completely according to the comparison result.

Step S18: Printing the ticket.

The printing mechanism prints the ticket, and the printed ticket is dispensed to the outside of the printing device by the paper feeding mechanism. The paper cutting mechanism cuts paper when the paper needs to be cut.

Step S20: alarming for paper absence.

When the length of residual paper in the paper roll is less than the length of the ticket to be printed, the printing device provides an alarm about the absence of paper, in order to prompt the user to discard the current paper roll and replace a new paper roll. Alarm prompt can be displayed by displaying device such as LED, LCD, also can be prompted by sound, such as sound created by buzzer or speaker.

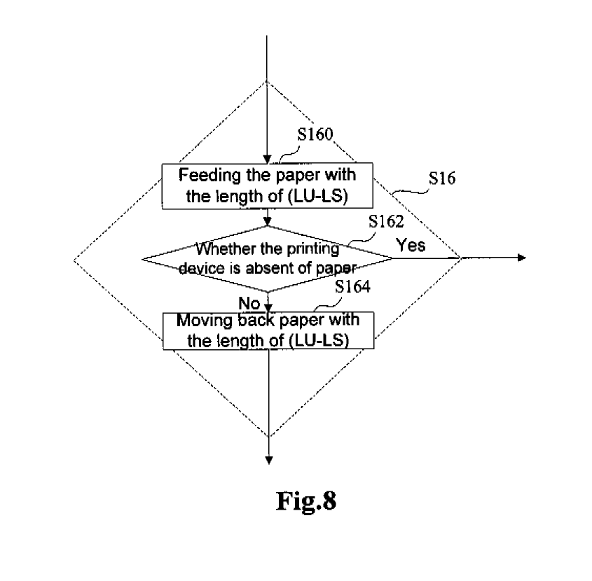

FIG. 8 is a flowchart of determining whether the residual amount of paper of the paper roll is enough to print a ticket completely according to the embodiment of the invention.

After the printing device detects that the paper is near end, it is necessary to further judge whether the length of the residual paper is enough to print a complete ticket. When the length of the residual paper is enough to print a complete ticket, the printing is performed. When the length of the residual paper is not enough to print a complete ticket, the user is prompted to replace a new paper roll so as to improve the detection accuracy of residual amount of paper, and not only improve the utilization rate of paper, but also prevent ticket from being printed incompletely.

How to judge the relationship between the length of residual paper and the length of the ticket to be printed after the printing device detects that the paper is near end is described in detail below in conjunction with FIG. 5, FIG. 6 and FIG. 8. For convenient description, the distance between the paper absent detection mechanism and the printing mechanism is recorded as LS.

As shown in FIG. 8, the method comprises the following steps:

Step S160: The printing device feeds paper according to the set length.

The printing device feeds paper according to the set length, and detects the relationship between the length of residual paper and the length of the ticket to be printed by means of the paper absent detection device. The set length can be the length LU of the ticket to be printed, also can be |LU−LS|, i.e., be the absolute value of the difference between the length LU of the ticket to be printed and the distance LS between the paper absent detection mechanism and the printing position. The paper is fed according to the length LU of the ticket to be printed, and it is possible to detect whether the length of residual paper at upstream of the paper absent sensor is greater than the length of the ticket to be printed, so as to determine whether the length of residual paper is enough to print a complete ticket. Because the residual paper with the length of LS is remained between the paper absent detection mechanism and the printing mechanism, the paper is fed according to |LU−LS|, i.e., the absolute value of the difference between the length LU of the ticket to be printed and the distance LS between the paper absent detection mechanism and the printing position, and the residual paper between the paper absent detection mechanism and the printing mechanism can be used fully.

Step S162: At the time of stopping paper feeding, it is judged whether the printing device is absent of paper. If yes, Step S20 is executed; otherwise Step S164 is executed.

The paper absent detection device compares the relationship between the printed actual feeding length and the set length. At the time of stopping paper feeding, if the paper absent detection device detects paper present, it is indicated that the length of the paper remained at upstream of the printing device is greater than the length of the ticket to be printed, therefore the complete ticket can be printed and there is no ticket which is printed incompletely. At the time of stopping paper feeding, if the paper absent detection device detects the absence of paper, it is indicated that the length of the paper remained at upstream of the printing device is smaller than the length of the ticket to be printed, i.e., the current residual amount of paper is not enough to completely print the ticket. The paper absent detection mechanism is usually a photoelectric sensor or mechanical sensor. Since the sensor is in different states in the case of paper present and paper absence, it is possible to detect whether there is paper or not in the position where the paper absent detection mechanism is located. Generally, the paper absent detection mechanism detects the state of the printing paper in real time. During printing, once the paper absent detection mechanism detects the absence of paper, the printer stops feeding paper.

Step S164: The printing device moves back paper according to the feeding length in Step S160.

The printing device moves back paper according to the feeding length in Step S160, i.e., the paper is moved back according to the feeding length for preparing the printing.

The paper feeding operation and paper moving back operation of the printing device finishes the operation of judging whether the residual paper in the paper roll is enough to print the complete ticket. After Step S164 is executed, Step S18 is executed to print the ticket.

In the process of printing ticket, when the residual amount of paper is relatively small in the printing device, i.e., when the paper is near end, the residual amount of paper in the paper roll can be limited to the length of one ticket through first judging whether the residual amount of paper in the paper roll is enough to print the ticket completely before printing one ticket and then printing the ticket when it is determined that the ticket can be completely printed, which can be implemented on the common printing paper which is not specially designed, reducing the waste of paper, improving the utilization rate of paper as well as ensuring the completeness of printed ticket.

It can be seen from the above description that, in the invention, in the process of printing ticket, when the residual amount of paper is relatively small in the printer, i.e., when the paper is near end, the print control method of first determining whether the residual amount of paper can ensure that the ticket content is completely printed before printing one ticket is used. The invention not only reduces the residual amount of paper as much as possible, but also ensures the completeness of the printed ticket to prevent the ticket from being half. Moreover, the invention greatly improves the utilization rate and printing efficiency of the printing paper without using special printing paper and without increasing the cost of the printer.

According to the embodiment of the invention, there is provided a print control device.

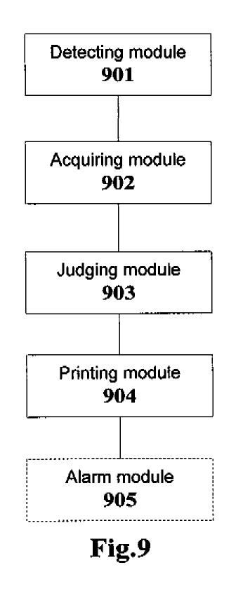

FIG. 9 is a schematic diagram of a print control device according to the embodiment of the invention.

As shown in FIG. 9, the print control device comprises: a detecting module 901, an acquiring module 902, a judging module 903 and a printing module 904.

In the above, the detecting module 901 is used for detecting a state of a printing paper of a printing device; the acquiring module 902 is used for acquiring the length of a ticket to be printed when the printing device is in a paper near end state; the judging module 903 is used for judging whether the printing paper in the printing device is enough to print the ticket to be printed completely according to the length of the ticket to be printed; and the printing module 904 is used for printing the ticket to be printed under the condition of determining that the ticket to be printed can be completely printed.

Preferably, the print control device also comprises an alarm module 905.

The alarm module 905 is used for providing an alarm for a user when the printing device is in a paper absent state.

It should be noted that, the steps shown in the flowchart of the drawings can be executed in a computer system such as a group of computer-executable instructions, and although the logical order is shown in the flowchart, in some cases, the steps shown or described can be executed in an order different from here.

Obviously, those skilled in the art should understand that, each module or each step of the invention can be implemented by the general-purpose computing device, modules or steps can be focused on the single computing device, or distributed on the network composed of a plurality of computing devices, optionally, can be implemented by program codes which can be executed by the computing device, and thus, modules or steps can be stored in the storage device and executed by the computing device, or modules or steps can be implemented by making them into various integrated circuit modules respectively, making most of them into single integrated circuit module. In this way, the invention is not limited to any particular combination of hardware and software.

The above is only the preferred embodiment of the invention and not intended to limit invention. For those skilled in the art, various alterations and changes may be made to the invention. Any modifications, equivalent replacements, improvements and the like made within the spirit and principle of the invention shall fall within the scope of protection of the invention.

1. A print control method, comprising:
detecting a state of a printing paper of a printing device;
acquiring the length of a ticket to be printed when the printing device is in a paper near end state;
judging whether the printing paper in the printing device is enough to print the ticket to be printed completely according to the length of the ticket to be printed; and
printing the ticket to be printed under the condition of determining that the ticket to be printed can be completely printed.

2. The method according to claim 1, wherein the step of detecting a state of a printing paper of a printing device comprises:
judging whether the printing device is in the paper near end state through querying a state of a paper near end sensor.

3. The method according to claim 1, wherein the step of judging whether the printing paper in the printing device is enough to print the ticket to be printed completely according to the length of the ticket to be printed comprises:
feeding paper by the printing device according to a set length;
comparing an actual feeding length of the printing device with the set length at the time of stopping paper feeding;
judging whether the printing paper in the printing device is enough to print the ticket to be printed completely according to the comparison result.

4. The method according to claim 3, wherein when the printing paper in the printing device is enough to print the ticket to be printed completely, the method further comprises:
moving back paper according to the set length.

5. The method according to claim 3, wherein the set length is the length of the ticket to be printed or the difference between the length of the ticket to be printed and a LS, wherein the LS is a distance between a paper absent detection mechanism and a printing position.

6. The method according to claim 1, wherein the ticket to be printed is a ticket with a fixed length or a ticket with a random length, when the ticket to be printed is the ticket with a fixed length, the step of acquiring the length of the ticket to be printed comprises:
acquiring the length of the ticket to be printed according to the length of the ticket with a fixed length prestored.

7. The method according to claim 1, wherein the ticket to be printed is a ticket with a fixed length or a ticket with a random length, when the ticket to be printed is the ticket with a random length, the step of acquiring the length of the ticket to be printed comprises:
calculating the length of the ticket to be printed according to received print data of the ticket to be printed.

8. The method according to claim 1, wherein when the printing device is in a paper absent state, the method further comprises:
providing an alarm for a user.

9. A print control device, comprising:
a detecting module, configured to detect a state of a printing paper of a printing device;
an acquiring module, configured to acquire the length of a ticket to be printed when the printing device is in a paper near end state;
a judging module, configured to judge whether the printing paper in the printing device is enough to print the ticket to be printed completely according to the length of the ticket to be printed; and
a printing module, configured to print the ticket to be printed under the condition of determining that the ticket to be printed can be completely printed.

10. The device according to claim 9, wherein the device further comprises:
an alarm module, configured to provide an alarm for a user when the printing device is in a paper absent state.

11. The method according to claim 4, wherein the set length is the length of the ticket to be printed or the difference between the length of the ticket to be printed and a LS, wherein the LS is a distance between a paper absent detection mechanism and a printing position.
